(19) United States
(12) Patent Application Publication
(10) Pub. No.: US 2011/0254363 A1
(43) Pub. Date: Oct. 20, 2011

(54) TRACK ASSEMBLY FOR A MOTORIZED VEHICLE

(76) Inventor: Denis BOIVIN, Beaumont (CA)

(21) Appl. No.: 12/763,666

(22) Filed: Apr. 20, 2010

(51) Int. Cl. B62D 55/084; B23P 11/00; B62D 55/088

(52) U.S. Cl. 305/100; 305/120; 29/428

(57) ABSTRACT

A track assembly for a motorized vehicle having wheels comprises a longitudinal endless track belt; a mounting structure to mount the longitudinal endless track belt to the vehicle; and inner wheels in contact with an inner surface of the track belt. The mounting structure includes driving gears disposed externally to the track belt and configured to frictionally engaged an outer surface of one of the motorized vehicle wheels. The driving gears are drivingly connected with the track belt for transmitting power thereto. Each one of the driving gears has a rotation axis, a plurality of elongated traction bars extending substantially parallel and circumferentially to the rotation axis, and apertured ends. The elongated traction bars are spaced-apart from one another and define therebetween channels allowing granular and liquid materials to flow inwardly towards the rotation axis, and outwardly of the driving gears through the apertured ends.

### TECHNICAL FIELD OF THE INVENTION

The technical field relates to motorized vehicles and, more particularly to track assemblies engageable with a wheel and tire assembly of a motorized vehicle.

### BACKGROUND

It is well known that many people drive their vehicles, including trucks, cars and other types of vehicles, through all types of terrain and road (or off-road) conditions. In difficult driving conditions (collectively referred to as ‘adverse conditions’) such as snow, sand, gravel, mud, ice, and the like, wheeled vehicles often have considerable propelling difficulties.

Traction (or track) assemblies, or track units, have been developed for converting a wheeled driven vehicle, such as trucks, cars, SUV, all-terrain vehicles, and the like, into a track-like driven vehicle for improved traction in certain types of terrain and driving conditions.

Typically for mounting a track assembly to a wheeled vehicle, the wheels and tires must be removed on each axle of the vehicle and are replaced by track assemblies [See for instance U.S. Pat. Nos. 7,131,508; 6,904,986 and 5,607,210]. The installation or removal of the track assemblies must be carried out in a specialized facility. Once mounted, the track assemblies cannot be easily removed. Furthermore, they are relatively expensive.

There is thus a need for a track assembly for a wheeled vehicle which does not require removal of the wheels, which is relatively easy and quick to install, and effective for improving traction for standard motorized vehicles in adverse conditions.

### BRIEF SUMMARY OF THE INVENTION

It is therefore an aim of the present invention to address the above mentioned issues.

According to a general aspect, there is provided a track assembly for a motorized vehicle having wheels. The track assembly comprises: a longitudinal endless track belt having an outer surface and an inner surface; a mounting structure to mount the longitudinal endless track belt to the vehicle, the mounting structure including at least one driving gear disposed externally to the longitudinal endless track belt and configured to frictionally engaged an outer surface of one of the motorized vehicle wheels, the at least one driving gear being drivingly connected with the longitudinal endless track belt for transmitting power thereto, each one of the at least one driving gear having a rotation axis, a plurality of elongated traction bars extending substantially parallel and circumferentially to the rotation axis, and apertured ends, the elongated traction bars being spaced-apart from one another and defining therebetween channels allowing granular and liquid materials to flow inwardly towards the rotation axis, and outwardly of the at least one driving gear through the apertured ends; and inner wheels in contact with the inner surface of the longitudinal endless track belt.

In an embodiment, the mounting structure comprises two driving gears located respectively forwardly and rearwardly of the engageable motorized vehicle wheel and the apertured ends extending radially from the rotation axis.

In an embodiment, the at least one driving gear comprises a radial support connecting an axle of the driving gear and the traction bars and maintaining the traction bars in a radially spaced-apart relationship and each one of the traction bars having two opposed ends unattached to the axle and thereby defining the apertured ends of the at least one driving gear.

In an embodiment, the at least one driving gear is drivingly connected through meshed linkages with the longitudinal endless track belt for transmitting power thereto without slippage.

The longitudinal endless track belt can rotate in the rotational direction of the motorized vehicle wheel when actuated.

In an embodiment, the at least one driving gear comprises a plurality of traction bar units, each one of the traction bar units including at least two traction bars, the traction bar units being spaced-apart from one another and defining a channel therebetween, the elongated track belt being in meshing engagement with the channels defined between two circumferentially consecutive traction bar units.

A track assembly can comprise at least one attachment chain having a first end secured to the mounting structure and a second end securable to the motorized vehicle. The second end can be securable to the wheel axle.

In an embodiment, the mounting structure comprises two spaced-apart side guiding plates including rollers for receiving the vehicle wheel therebetween and being mounted externally of the longitudinal endless track belt. The distance between the side guiding plates can be adjustable.

According to another general aspect, there is provided a motorized vehicle including four detachable track assemblies to support the vehicle onto a ground surface and having four wheels, each one of the track assemblies comprising: a frame; a longitudinal endless track belt movably mounted to the frame; inner wheels rotatably mounted to the frame and in contact with an inner surface of the longitudinal endless track belt; at least two driving gears disposed externally to the longitudinal endless track belt and being in frictional driving engagement with one of the four motorized vehicle wheels for rotation therewith, located above the longitudinal endless track belt and drivingly connected to the endless track belt for transmitting motion thereto, each one of the driving gears having a central rotation axis with a plurality of elongated traction bars extending substantially parallel and circumferentially to the central rotation axis, the elongated traction bars being radially spaced-apart from the rotation axis and from one another.

In an embodiment, the driving gears have open ends and/or are drivingly meshed with the longitudinal endless track belt.

In an embodiment, the driving gears comprise a radial support connecting an axle of the driving gears and the traction bars and maintaining the traction bars in a radially spaced-apart relationship and each one of the traction bars having two opposed ends unattached to the axle and thereby defining the open ends of the driving gears.

In an embodiment, the driving gears comprise a plurality of traction bar units, each one of the traction bar units including at least two traction bars, the traction bar units being spaced-apart from one another and defining a channel therebetween, the elongated track belt being in meshing engagement with the channels defined between two circumferentially consecutive traction bar units.

Each one of the track assemblies can comprise at least one attachment chain having a first end secured to the mounting structure and a second end securable to the motorized vehicle.

In an embodiment, the mounting structure comprises two spaced-apart side guiding plates including rollers for receiving the vehicle wheel therebetween and being mounted externally of the longitudinal endless track belt.

According to still another general aspect, there is provided a driving gear for transferring power from a vehicle wheel to a track of a vehicle track assembly, the driving gear comprising a body in the shape of a hollow cylinder having two spaced-apart open ends, a central axle and a plurality of longitudinally oriented, and regularly circumferentially interspaced traction bars defining the cylindrical shape and being adapted for receiving traction from the vehicle wheel, and a plurality of channels interspersed between corresponding ones of the traction bars, the channels being shaped for evacuating snow from the track inside the hollow cylinder and out the two open ends.

In an embodiment, the driving gear comprises a radial support connecting the axle and the traction bars and maintaining the traction bars in a radially spaced-apart relationship and each one of the traction bars having two opposed ends unattached to the axle and thereby defining the open ends of the driving gears.

In an embodiment, the driving gear comprises a plurality of traction bar units, each one of the traction bar units including at least two traction bars, the traction bar units being spaced-apart from one another and defining the interspersed channels therebetween.

According to a further general aspect, there is provided a method of mounting at least one vehicle track assembly to a vehicle, the method comprising laying the at least one vehicle track assembly on the ground, attaching at least one ramp to one end of each one of the at least one vehicle track assembly, displacing the vehicle for a wheel thereof to mount the at least one ramp and drop into an operative position in the at least one vehicle track assembly, and removing the at least one ramp.

In an embodiment, the at least one ramp comprises an attachment bar mating and engageable with a channel defined in a driving gear of the at least one track assembly for preventing rotation of the driving gear.

In an embodiment, attaching the at least one ramp comprises inserting a first attachment male member of the at least one ramp in a mating slot of the at least one track assembly and inserting an attachment bar of the at least one ramp in a mating channel defined in a driving gear of the at least one track assembly and between two circumferentially consecutive traction bars of the at least one track assembly for preventing rotation of the driving gear.

According to another general aspect, there is provided a track unit kit for a motorized vehicle having a plurality of wheels, the track unit kit comprising: a track assembly including a frame, a longitudinal endless track belt movably mounted to the frame, inner wheels rotatably mounted to the frame and in contact with an inner surface of the longitudinal endless track belt, and at least two driving gears disposed externally to the longitudinal endless track belt, located above the longitudinal endless track belt and drivingly connected to the endless track belt for transmitting motion thereto, each one of the driving gears having a central rotation axis with a plurality of elongated traction bars extending substantially parallel and circumferentially to the central rotation axis, the elongated traction bars being radially spaced-apart from the rotation axis and from one another for defining channels therebetween; and a ramp for mounting and dismounting the vehicle wheels from the track assembly above the endless track belt and between the driving gears, the ramp having an attachment bar mating and engageable with one of the channels defined in the driving gears and preventing rotation of the driving gears during mounting and dismounting the vehicle wheels from the track assembly.

In an embodiment, the frame of the track assembly comprises a slot defined therein and the ramp comprises an attachment male member removably insertable in the slot for attaching the ramp to the track assembly.

In this specification, the term “vehicle wheel” is intended to mean the wheel of the vehicle including or not the tire surrounding the wheel.

### BRIEF DESCRIPTION OF THE DRAWINGS

FIG. 1 is a side elevation view of a motorized vehicle including track assemblies in accordance with an embodiment;

FIG. 2 is a perspective view of one of the track assemblies shown in FIG. 1 including an endless track belt;

FIG. 3 is a perspective view of the track assembly shown in FIG. 2 wherein the endless track belt is removed;

FIG. 4 is a side elevation view of the track assembly shown in FIG. 2 including the endless track belt and wherein an inside mounting plate is removed; and

FIG. 5 is a perspective view of a track driving wheel of the track assembly shown in FIG. 2 in accordance with an embodiment; and

FIG. 6 is top plan view of the track driving wheel shown in FIG. 5.

It will be noted that throughout the appended drawings, like features are identified by like reference numerals.

### DETAILED DESCRIPTION

A track assembly 20 adapted to be retrofitted to a motorized vehicle 22 in accordance with an embodiment will now be described in details with reference to the appended drawings.

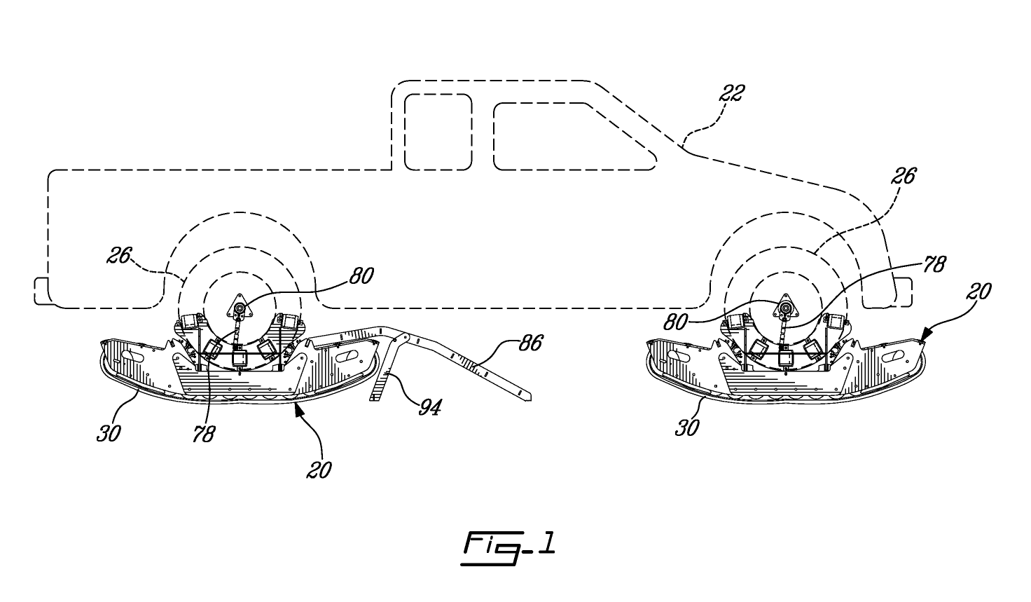

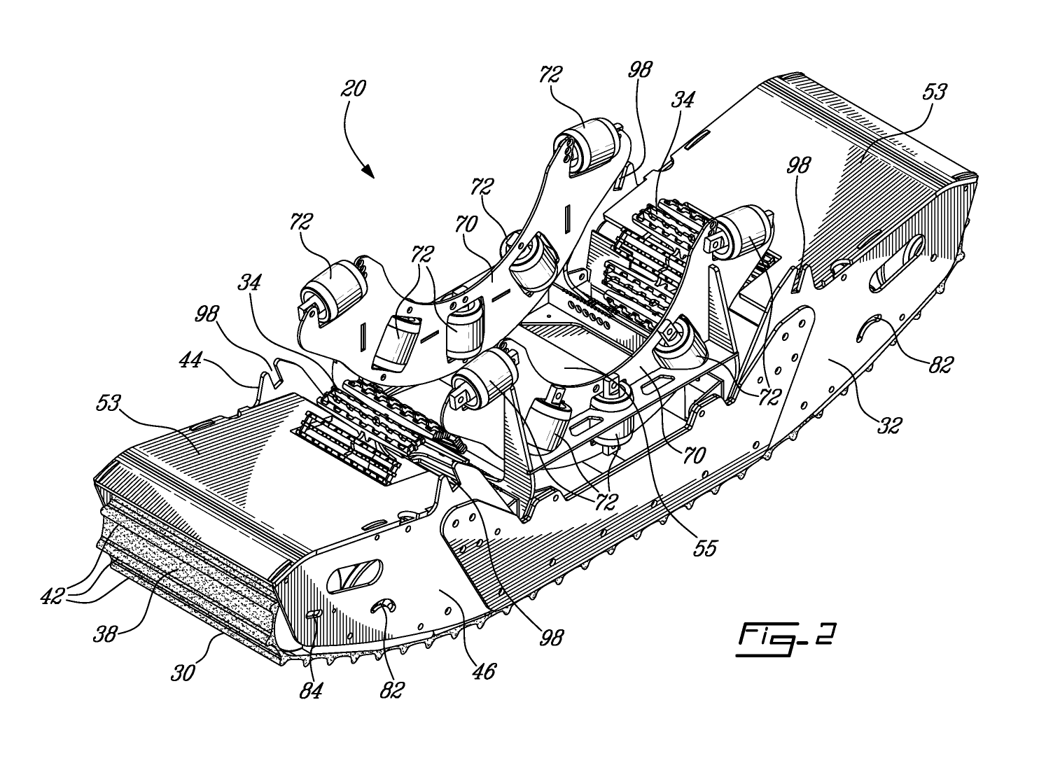

FIG. 1 shows a motorized vehicle 22 and, more particularly a pick-up truck, including a body and four track assemblies 20 (only two are shown) arranged in a plane adjacent to each side of the vehicle 22. The four track assemblies 20 of the motorized vehicle 22 are identical and are mounted to the conventional wheel and tire assemblies 26 of the motorized vehicle 22. Only one track assembly 20, visible in FIG. 1, will be described hereinbelow.

As mentioned above, the terminology “vehicle wheel 26” will be used herein to designate the vehicle wheel including or not its surrounding tire.

Referring to FIG. 2, it will be seen that the track assembly 20 includes a longitudinal endless track belt 30 and a mounting structure 32 to mount the endless track belt 30 to the vehicle 22. The mounting structure 32 includes, amongst others, a pair of track driving gears 34 disposed on opposite sides of the rotation axis of the vehicle wheel 26, a plurality of inner idler wheels 36 disposed inside the longitudinal endless track belt 30, and supports to interconnect the wheels 34, 36, as it will be described hereinbelow. As it can be seen from FIGS. 1, 2, and 4, the vehicle wheel 26 and the driving gears 34 are external to endless track belt 30. The endless track belt 30 is wounded around the inner idler wheels 36 while the vehicle wheel 26 and the driving gears 34 are located outside the loop defined by endless track belt 30.

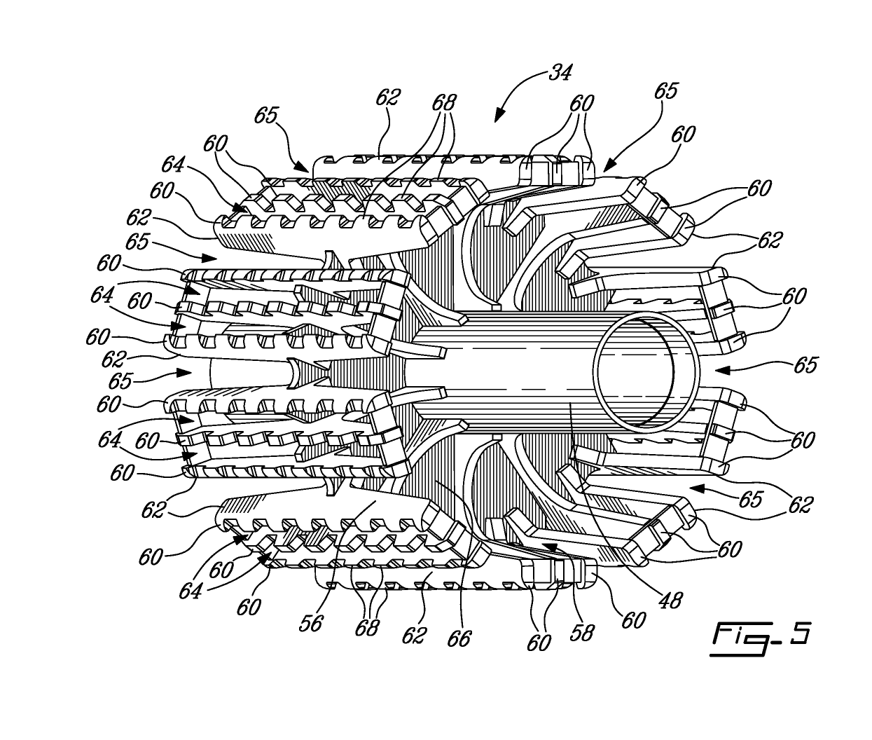

Referring to FIGS. 2 and 4, the endless track belt 30 is made of an elastomeric material and has an outer surface 38 for contact with the ground and an inner surface 40. The outer surface 38 is provided with transversal lugs 42 and is adapted to engage with the driving gears 34. More particularly, in the embodiment shown, the driving gears 34 meshingly engage with the equidistant transversal lugs 42. However, it is appreciated that in an alternative embodiment (not shown), the endless track belt 30 can be provided with equidistant longitudinally spaced-apart openings separated by bridging webs for engagement with the driving gears 34.

The mounting structure 32 further includes an inside mounting plate 44 and an outside mounting plate 46, spaced-apart from the inside mounting plate 44. The driving gears 34 and the inner wheels are interconnected with the inside and outside mounting plates 44, 46, with the driving gears 34 being disposed externally to track belt 30. As it will be described in further details below, the inside and outside mounting plates 44, 46 support the axle 48 of the driving gears 34 and the inner idler wheels 36 through a plurality of supports 50, 52 extending parallel to one another and extending between the inside and outside mounting plates 44, 46. More particularly, each of the driving gears 34 is rotatably mounted to support 52 which connect the inside and outside mounting plates 44, 46. The support 52 is concentric with the axle 48. The driving gears 34 are rotatable about the support 52.

The track assembly 20 further includes two spaced-apart cover plates 53, extending above the track belt 30, on the front and the rear end of the track assembly 20 and between the inside and outside mounting plates 44, 46. It also includes a central cover plate 55 extending between both driving gears 34. The cover plates 53, 55 prevent access to the track belt 30 and reduce the amount of granular material in contact with the track belt 30 and the driving gears 34 during operation.

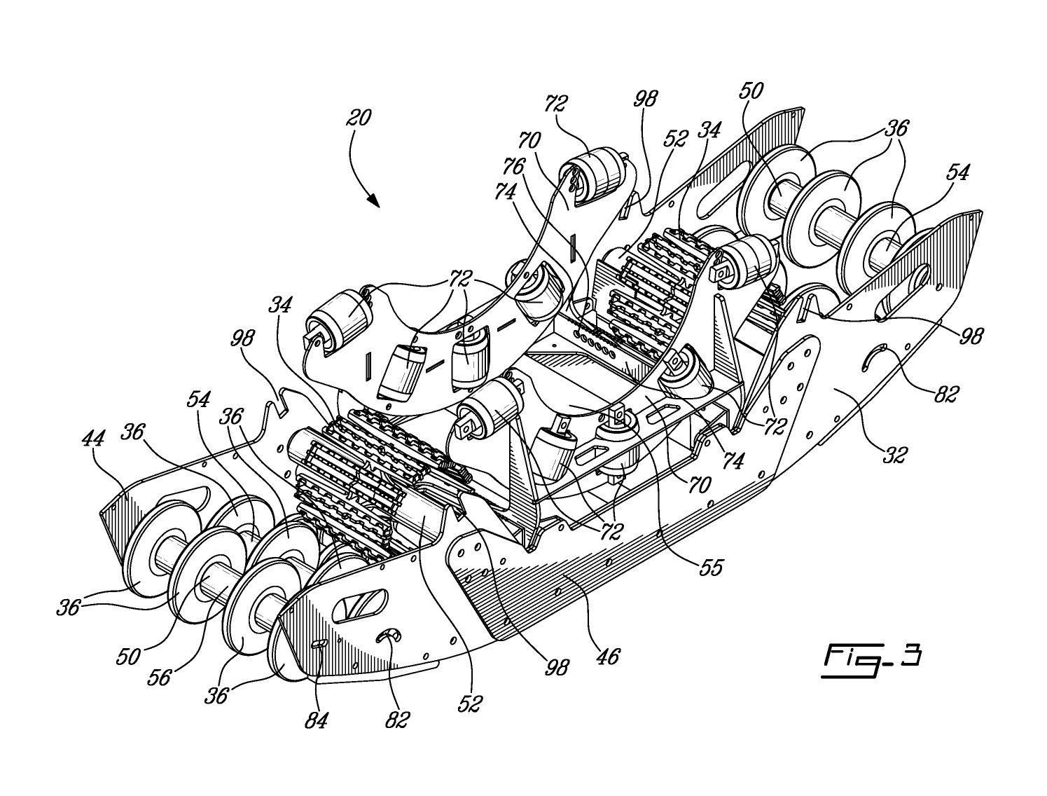

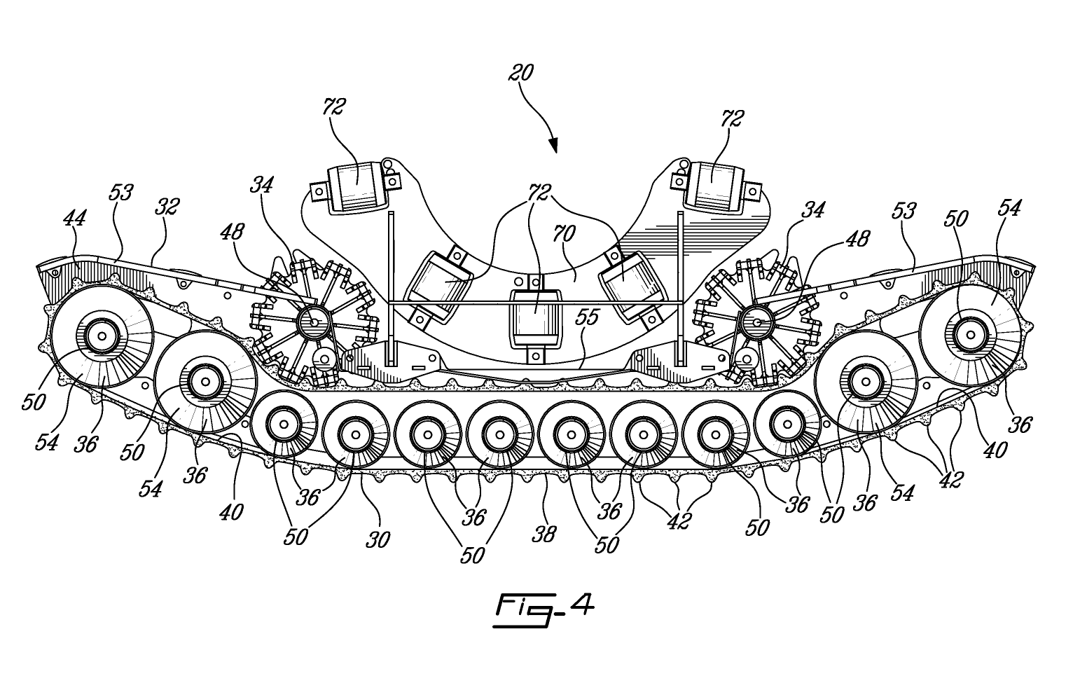

Referring now to FIGS. 3 and 4, the configuration of the inner idler wheels 36 will be described in further details. The endless track belt 30 is supported by a plurality of idler wheel rows, connected together through the inside and outside mounting plates 44, 46. Each one of the inner idler wheels 36 has a peripheral portion in contact with the inner surface of the track belt 30 and rotates therewith. The idler wheels 36 close to the track belt ends have a larger diameter than the internal idler wheels 36 as shown in FIG. 4. More particularly, the last and the next-to-last front and rear idler wheel rows 54 include idler wheels 36 of larger diameter than the idler wheel rows extending therebetween.

The inner idler wheels 36 are also rotatably mounted on supports 50 which connect the inside and outside mounting plates 44, 46 and are secured thereto. In the embodiment shown, each support 50 has four spaced-apart idler wheels 36 rotatably mounted thereto. It is appreciated that in alternative embodiments, any number of inner idler wheels 36 can be rotatably mounted to each support 50. Furthermore, the idler wheels 36 of two consecutive rows are disposed in a staggered relationship. However, it is appreciated that the idler wheels 36 of consecutive rows can be the same planes, i.e. aligned with one another.

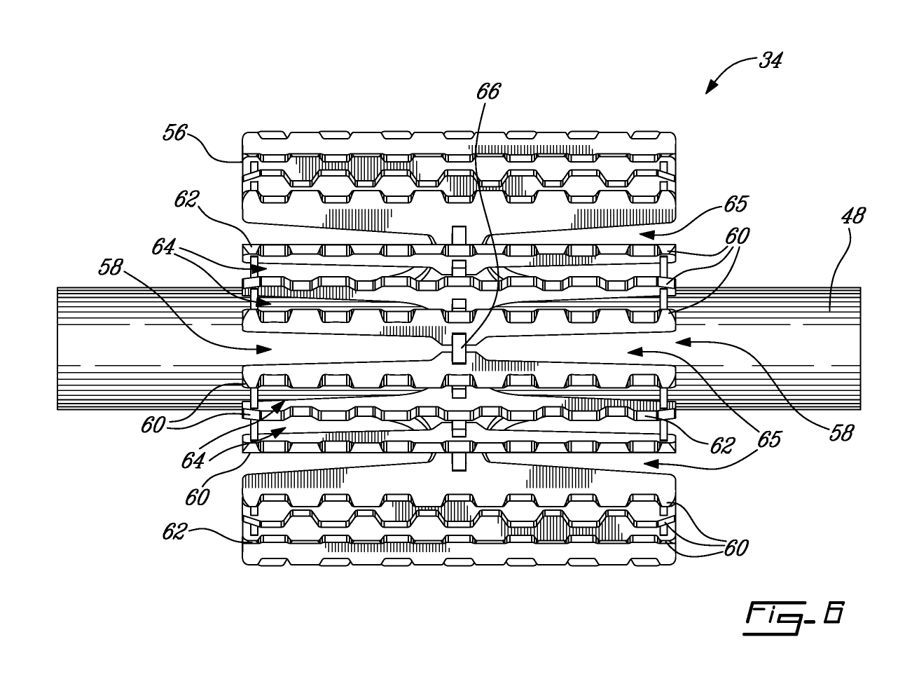

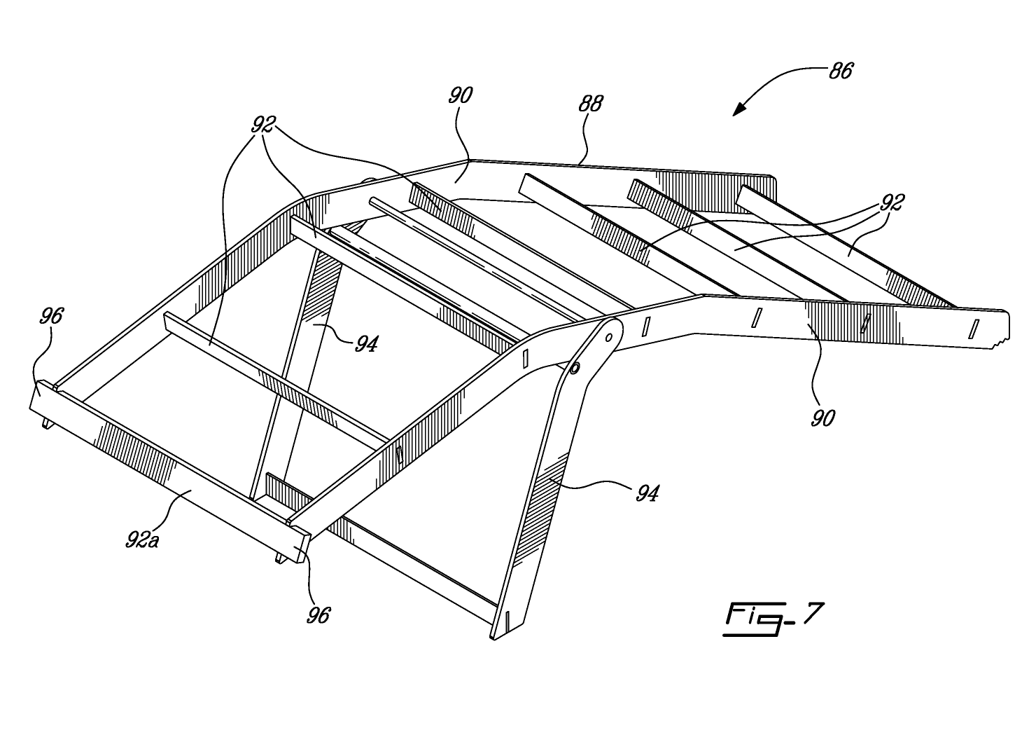

Referring now simultaneously to FIGS. 5 and 6, it will be seen that driving gears 34 have a body 56 in the shape of a hollow cylinder with two spaced-apart open ends 58, a central axle 48, and a plurality of elongated and substantially regularly circumferentially interspaced traction bars 60. In other words, the traction bars 60 are arranged in a circle around the driving gear axle 48. The traction bars 60 define the cylindrical shape of the driving gears 34 and extend substantially parallel to the axle 48. The traction bars 60 are divided in equidistant traction bar units 62 wherein each unit 62 includes three traction bars 60, spaced-apart from one another. Each traction bar 60 of one unit 62 are connected at their ends. Channels or slots 64, 65 are defined between adjacent (or circumferentially consecutive) traction bars 60 in the traction bar unit 62 and between adjacent (or circumferentially consecutive) traction bar units 62. The channels 65 between two consecutive traction bar units 62 are larger than the channels 64 between two consecutive traction bars 65 within one traction bar unit 62. The channels 62 are shaped for evacuating granular and liquid materials such as snow, sand, gravel, mud, ice, and the like from the vehicle tire and the track belt 30 inside the hollow cylinder of the driving gears 34 and then out the two open ends 58 of the driving gears 34. The granular and liquid materials are extruded inside and then outwardly of the driving gears 34 to reduce slippage and congestion of driving gears 34. In the embodiment shown, the ends of the traction bars 60 are unattached to the axle 48.

The traction bars 60 are connected to the axle 48 through a radial support 66 which extends substantially centrally of the traction bars 60. The radial support 66 maintains the elongated traction bars 60 in a radially spaced-apart relationship with the axle 48.

As mentioned above, the driving gears 34 are located respectively forwardly and rearwardly of the motorized vehicle wheels 26, and the traction bars 60 are adapted for receiving traction from the vehicle wheels 26. In the operative configuration, the vehicle wheel 26 is seated between the two driving gears 34.

For reduced slippage during rotational frictional engagement with the vehicle wheels 26 and, more particularly with the surrounding tire (if any), an outer edge of the traction bar 60 includes a plurality of lugs 68 integrally formed and separated by indentations, i.e. a plurality of projections that help to provide traction. In a traction bar unit 62, two successive rows of lugs 68 are arranged in a staggered relationship to promote traction. The lugs 68 define the wheel (or tire) contacting surface of the driving gears 34.

In an alternative embodiment, the open ends 58 could be apertured ends, i.e. ends having apertures defined therein allowing the granular and liquid materials to flow outwardly of the driving gears 34. For instance and without being limitative, the driving gears 34 can include at least two spaced-apart radial supports having apertures defined therein and secured to the traction bars 60 close to their ends and to the support 52. In another alternative embodiment, spaced-apart rods can attach the ends of the traction bars 60 to the axle 48.

In an alternative embodiment, the hollow body of the driving gears 34 can include one or several protruding stem(s) which act as extrusion members for breaking agglomeration of granular material and pushing the granular material outside the driving gears 34 through the open or apertured ends.

It is appreciated that the number and configuration of traction bars 60 and traction bar units 62 can vary.

As mentioned above, the hollow shape of the driving gears 34 and more particularly channels 64, 65 allow the evacuation of granular and liquid materials such as snow, sand, gravel, mud, ice, and the like from the vehicle tire and the track belt 30 inside the hollow cylinder of the driving gears 34 and then out the two open ends 58 of the driving gears 34. The granular and liquid materials are extruded inside and then outwardly of the driving gears 34 to reduce slippage and congestion of driving gears 34.

The traction bar units 62 cooperate with transversal lugs 42 of the endless track belt 30 for propelling the vehicle 22. More particularly, the traction bar units 62 are in driving engagement with the lugs 42, i.e. the traction bar units 62 are inserted between two consecutive transversal lugs 42 and apply pressure to the latter to rotate the track belt 30. The traction bar units 62 are spaced out so that the distance between two consecutive traction bar units 62 spans the distance separating consecutive transversal lugs 42, in a meshing engagement, in such a way as to drive the endless track belt 30.

As stated hereinabove, the track assembly 20 is provided with an external gearing, i.e. the track driving gears 34 are located externally of endless track belt 30. The endless track belt 30 has a plurality of equidistant transversal lugs 42, which ensure a positive engagement with the traction bars 60 provided on the outer circumference of track driving gears 34. In operation, the wheels and tires 26 of the vehicle 22 are in rotational frictional engagement with the track driving gears 34 and the rotational movement of the wheels and tires 26 is transmitted to the track driving gears 34. The track driving gears 34 are in meshing or gearing engagement with the track belt 30 for transmitting rotational motion.

As it will be easily understood by one skilled in the art, the driving gear 34 can cooperate with either transversal lugs 42 of the endless track belt 30 or with bridging webs, whichever the endless track belt 30 includes.

Thus, the engine of the motorized vehicle 22 drives the vehicle wheel 26 in rotation. The vehicle wheel 26 thus drives both track driving gears 34 in rotation by frictional engagement between an outer surface of the vehicle wheel 26 (or tire, if any) and the elongated traction bars 60 of the driving gears 34. The track driving gears 34 drive the endless track belt 30 in rotation by the meshing engagement of the elongated traction bars 60 with the transversal lugs 42 of the endless track belt 30. It is further to be understood that the transversal lugs 42 on the external circumference surface 38 of the endless track belt 30 also exert a positive mechanical connection with the underlying ground surface that contributes to propel the motorized vehicle 22.

The track assembly 20 further includes two spaced-apart side guiding plates 70 including rollers 72 for receiving the vehicle wheel 26 therebetween in an operative configuration. The side guiding plates 70 are mounted externally of the longitudinal endless track belt 30. The distance between the two side guiding plates 70 substantially corresponds to the width of the vehicle wheel 26 (including its tire, if any). In the embodiment shown, the side guiding plates 70 have a substantially annular shape. However, it is appreciated that the shape can vary in alternative embodiments (not shown). The side guiding plates 70 ensure that the vehicle wheel 26 remains on the track assembly 20 when mounted thereto and prevents side slippage from the track assembly 20. The rollers 72 are rotatably mounted in apertures defined in the side guiding plates 70 and are oriented in a substantially radial configuration with the vehicle wheel 26. They are positioned to abut the lateral faces of the vehicle wheel 26 when the latter is mounted to the track assembly 20, which lower friction and simultaneously guide the vehicle wheel 26 and prevent side slippage. In the embodiment shown, each one of the side guiding plates 70 include five rollers 72; however, it is appreciated that in alternative embodiments (not shown), the side guiding plates 70 can include more or less rollers. In another alternative embodiment, the side guiding plates 70 can be roller free. In a further alternative embodiment, the track assembly 20 can be side guiding plate free.

The track assembly 20 can be mounted to vehicle wheel 26 of various diameters. To adapt the track assembly 20 to the size of the wheel 26, the distance between the two side guiding plates 70 can be adjusted. In the embodiment shown in FIG. 2, the side guiding plates 70 are connected together through transversal bars 74 having a plurality of apertures 76 defined therein and slidable relatively to one another. Therefore, the distance between the two side guiding plates 70 can be adjusted in accordance with the width of the vehicle wheel 26 and secured in the selected configuration by inserting fasteners in the apertures 76 in registry. It is appreciated that the mechanism for adjusting and securing the side guiding plate configuration can differ from the one shown. Furthermore, in an alternative embodiment, the entire track assembly width can be adjustable instead of solely the distance between the two side guiding plates 70.

The track assembly 20 can be secured to the vehicle 22 and/or the vehicle wheel 26. Referring back to FIG. 1, there is shown that the track assembly 20 includes an attachment chain 78 having a first end secured to the mounting structure 32, substantially centrally thereof and on the outer side of the track assembly 20, and a second opposed end secured to the motorized vehicle 22. In the embodiment shown and in the operative configuration of the track assembly 20, the second end is secured to the wheel axle 80. When attached to the vehicle 22, the chain 78 is substantially taut. When removing the vehicle wheel 26 from the track assembly 20, the second end of the attachment chain 78 can be unsecured.

Other embodiments can be foreseen for securing the track assembly 20 to the vehicle 22. In another non-limitative embodiment, the attachment chain 78 can be located on the inner side of the track assembly 20 and the second end can be secured to the vehicle frame. In a further non-limitative embodiment, two attachment chains can be used to secure the track assembly 20 to the vehicle frame. A first attachment chain can be secured forwardly of the vehicle wheel 26 and a second attachment chain can be secured rearwardly of the vehicle wheel 26.

In another embodiment (not shown), the track assembly 20 can include a belt (not shown) which surrounds the vehicle wheel 26 when mounted to the track assembly 20 in the operative configuration. The belt can have a plurality of rollers for reducing friction between the belt and the wheel 26 during operation. As the attachment chain 78 and the side guiding plates 70, the belt secures the vehicle wheel 26 to the track assembly 20 in the operative configuration and prevents side slippage from the track assembly 20.

In another embodiment (not shown), the track assembly 20 can include attachment bars (not shown) which extend from the mounting structure 32 and abut an upper surface of the vehicle wheel 26 when mounted to the track assembly 20 in the operative configuration. For instance and without being limitative, the attachment bars can have an inverted Y shape with two arms abutting the upper surface of the vehicle wheel 26. The attachment bars can have rollers for reducing friction between the latter and the wheel 26 during operation. The attachment bars secure the vehicle wheel 26 to the track assembly 20 in the operative configuration and prevent side slippage from the track assembly 20. In an embodiment, the length of the attachment bars can be adjustable through a slidable structure. Therefore, the length of the attachment bars can be adjusted in accordance with the diameter of the vehicle wheel 26.

As it will be easily understood by one skilled in the art upon inspection of FIGS. 2 and 3, the shape of the endless track belt 30 can be modified by adjusting the position of the next-to-last front and rear idler wheels 36. As it can be seen, the inside and outside mounting plates 44, 46 have semi-circular apertures 82 in which the supports 50 of the next-to-last front and rear rows of idler wheels 36 are mounted. By displacing the supports 50 of the next-to-last rows of front and rear idler wheels 36 within the semi-circular apertures 82, the shape of the endless track belt 30 can be modified. An endless track belt 30 having a C-shape is more maneuverable while an endless track belt 30 that is substantially flat offers better performance since it has a wider supporting footprint.

It is also possible to adjust the tension of endless track belt 30 with a tension adjusting assembly. As it can be seen from FIGS. 2 and 3, the inside and outside mounting plates 44, 46 include slotted apertures 84 in which the support 50 of the last row of rear idler wheels 36 is mounted. By displacing the support 50 of the last row of rear idler wheels 36 within the slotted apertures 84, the tension of endless track belt 30 is adjustable.

In an embodiment, it is possible to adjust the height of the track assembly 20 by modifying the position of driving track wheels relatively to wheel and tire assembly 26.

The track assemblies 20 can be provided as a kit with ramps 86 for mounting and dismounting the track assemblies 20 to the vehicle wheel 26 of the motorized vehicle 22. Referring to FIG. 1, there is shown an embodiment of a ramp 86 for mounting and dismounting the track assemblies 20. The ramp 86 has a frame 88 with two longitudinal bars 90, spaced-apart from one another, and a plurality of transversal bars 92, spaced-apart from one another and extending between the two longitudinal bars 88. The transversal bars 92 define the surface which supports the vehicle wheel 26 when displaced thereon for climbing and descending the vehicle wheel 26 on the track assembly 20. The ramp 86 also includes a pivotable leg 94 which stabilizes the ramp 86 when secured to one of the track assemblies 20. The last one of the transversal bars 92 of the ramp 86 is an attachment bar 92a which is engageable with one of the channels 65 in the driving gear 34 of the track assembly 20, between two adjacent traction bar units 62. When engaged in the channel 65, the attachment bar 92a secures the ramp 86 to the track assembly 20 and prevents rotation of the driving gear 34. The ramp 86 further includes another attachment member 96 and more particularly two male members which protrude outwardly from the longitudinal bars 90, close to the attachment bar 92a, and which are engageable in respective slots 98 defined in the inside and outside mounting plates 44, 46 for further attaching the ramp 86 to the track assembly 20. In the embodiment shown, slots 98 are provided on each side of the side guiding plates 70 for either attaching the ramp 86 to the front or rear sides of the track assembly 20. It is appreciated that the shape of the ramp 86 and the attachment mechanism can differ from the one described above and shown in the figures.

For mounting track assemblies 20 to a four wheeled vehicle 22, two first track assemblies 20 are laid on the ground, either forwardly or rearwardly of the vehicle 22, close to the respective front or rear set of vehicle wheels 26 and aligned therewith, i.e. in the same plane. For instance, the track assemblies 20 are first mounted to the rear vehicle wheels 26. Thus, the track assemblies 20 are laid on the ground rearwardly of the rear vehicle wheels 26 but aligned therewith. A ramp 86 is attached to each one of the track assemblies 20. The ramp 86 extends between the vehicle wheels 26 and the track assemblies 20. Then, the vehicle 22 is displaced rearwardly for the vehicle wheels 26 to climb the ramps 86 and drop into the operative position in the vehicle track assemblies 20. Then, the ramps 86 are removed and the track assemblies 20 are secured to the vehicle 22.

The other two track assemblies 20 are laid on the ground forwardly of the front vehicle wheels 26 and aligned therewith. Ramps 86 are attached to each one of the track assemblies 20. The ramps 86 extend between the vehicle wheels 26 and the track assemblies 20. Then, the vehicle 22 is displaced forwardly for the vehicle wheels 26 to climb the ramps 86 and drop into the operative position in the vehicle track assemblies 20. Then, the ramps 86 are removed and the track assemblies 20 are secured to the vehicle 22.

It is appreciated that the front track assemblies 20 can be mounted to the vehicle 22 first, prior to the rear track assemblies 20. It also appreciated that the track assemblies 20 can be positioned under the vehicle chassis, i.e. forwardly of the rear vehicle wheels 26 and rearwardly of the front vehicle wheels 26 for climbing the vehicle wheels 26 thereon.

For dismounting the track assemblies 20, i.e. descending the vehicle wheels 26 therefrom, one can begin either with the front or the rear track assemblies 20. For instance, for dismounting the front track assemblies 20, the latter are detached from the vehicle 22. The ramps 86 are positioned and attached to each one of the front track assemblies 20, for instance forwardly thereof. Then, the vehicle 22 is displaced forwardly for the vehicle wheels 26 to be disengaged from the vehicle track assemblies 20 and descend the ramp. Then, the ramps 86 are removed.

Then, for dismounting the rear track assemblies 20, the latter are detached from the vehicle 22. The ramps 86 are positioned and attached to each one of the rear track assemblies 20, for instance rearwardly thereof. Then, the vehicle 22 is displaced rearwardly for the vehicle wheels 26 to be disengaged from the vehicle track assemblies 20. Then, the ramps 86 are removed.

Similarly, it is appreciated that the rear track assemblies 20 can be dismounted from the vehicle 22 first, prior to the front track assemblies 20. It is also appreciated that the track assemblies 20 can be dismounted by displacing the vehicle 22 in the opposite direction, i.e. rearwardly of the front vehicle wheels 26 and forwardly of the rear vehicle wheels 26.

The wheels and tires of the motorized vehicle 22 remain mounted to the vehicle 22. No driving gear needs to be retrofitted to the existing hub of the motorized vehicle 22.

Alternatively, the track assembly 20 can only include two or more driving wheels 34 mounted externally of the track belt 30. Furthermore, distinct wheels can be used for frictional engagement with the vehicle wheel 26 and for meshing engagement with the track belt 30. Furthermore, the shape of the various components such as and without being limitative, the track belt, the mounting structure, the driving and idler wheels, the traction bars, the radial support, the ramps, and the like, can differ.

As people skilled in the art will understand, motorized vehicles 22 provided with four endless track assemblies 20, can be used for a wide range of operations and terrains, while being highly mobile and offering good running performance. The endless track structure maintains an adequate configuration over a variety of surfaces. Since it does not have sliding shoes, it can be used on any ground surface.

The track assembly 20 can be designed to provide support longitudinally and/or laterally under almost the entire motorized vehicle 22, including under the lower portion of the vehicle 22. It provides a wide supporting footprint that performs adequately in deep snow conditions. Moreover, as it can be seen in FIG. 1, the wings of the motorized vehicle are clear from the track assemblies 20. Therefore, even if the track assembly 20 pivots around wheel and tire assembly 26, the risk of interference with the wings and spoiling the latter is negligible.

The track assemblies allow conversion of wheeled passenger trucks and wheeled recreational all terrain vehicles (ATV) over to tracked vehicles able to operate over a wider range of terrains and operating conditions including, without being limitative, streams and river beds, sand, sodden soils and swamps, rocks, snow, ice, and the like. They are adapted to a wide variety of personal, passenger and commercial all terrain vehicles.

It will be obvious to people skilled in the art that the track assemblies 20 can be applied both in the case of a two-wheel drive vehicle 22 wherein the power is applied only to the front or rear track belt assemblies, and in the case of a four-wheel vehicle 22, wherein power is independently provided to each one of the four track assemblies 20. Moreover, the track assembly 20 can be used with motorized vehicle 22 of any cylinder capacity. It is also understood that, although the track assemblies 20 have been described in the context of a truck, the track assemblies 20 can be mounted on most types of motorized vehicles 22 such as, without being limitative, trucks, cars, sport utility vehicles (SUV), all-terrain vehicles, and the like.

As it will be further understood by one skilled in the art, the motorized vehicle 22, equipped with the track assemblies 20, may be viewed as a snow vehicle since it may be used on snow as efficiently as conventional snow vehicles such as snowmobiles, for example. The wide supporting footprint of the track assemblies 20 is an important factor allowing this good performance. However, the absence of sliding shoes allows the use of the motorized vehicle 22 on harder surfaces without the usual drawbacks of tracked vehicles.

Interestingly, the present track assembly 20 system can equip all four wheels of a motorized vehicle 22 or only the front or rear wheels thereof. A further possibility would be to use track assemblies 20 in place of the rear wheels of a vehicle 22, while mounting skis in place of the front wheels thereof. Another important advantage of the track assembly 20 is that the same track assembly 20 can be mounted in any position on the vehicle (front, rear, left and right) 22.

It is appreciated that the material of the various components of the track assemblies 20 and the ramps 86 can be adapted and can vary from the one mentioned above.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention. The scope of the invention is therefore intended to be limited solely by the scope of the appended claims.

1. A track assembly for a motorized vehicle having wheels, the track assembly comprising:
a longitudinal endless track belt having an outer surface and an inner surface;
a mounting structure to mount the longitudinal endless track belt to the vehicle, the mounting structure including
at least one driving gear disposed externally to the longitudinal endless track belt and configured to frictionally engaged an outer surface of one of the motorized vehicle wheels, the at least one driving gear being drivingly connected with the longitudinal endless track belt for transmitting power thereto, each one of the at least one driving gear having a rotation axis, a plurality of elongated traction bars extending substantially parallel and circumferentially to the rotation axis, and apertured ends, the elongated traction bars being spaced-apart from one another and defining therebetween channels allowing granular and liquid materials to flow inwardly towards the rotation axis, and outwardly of the at least one driving gear through the apertured ends; and
inner wheels in contact with the inner surface of the longitudinal endless track belt.

2. A track assembly as claimed in claim 1, wherein the mounting structure comprises two driving gears located respectively forwardly and rearwardly of the engageable motorized vehicle wheel and the apertured ends extending radially from the rotation axis.

3. A track assembly as claimed in claim 1, wherein the at least one driving gear comprises a radial support connecting an axle of the driving gear and the traction bars and maintaining the traction bars in a radially spaced-apart relationship and each one of the traction bars having two opposed ends unattached to the axle and thereby defining the apertured ends of the at least one driving gear.

4. A track assembly as claimed in claim 1, wherein the at least one driving gear is drivingly connected through meshed linkages with the longitudinal endless track belt for transmitting power thereto without slippage.

5. A track assembly as claimed in claim 1, wherein the longitudinal endless track belt rotates in the rotational direction of the motorized vehicle wheel when actuated.

6. A track assembly as claimed in claim 1, wherein the at least one driving gear comprises a plurality of traction bar units, each one of the traction bar units including at least two traction bars, the traction bar units being spaced-apart from one another and defining a channel therebetween, the elongated track belt being in meshing engagement with the channels defined between two circumferentially consecutive traction bar units.

7. A track assembly as claimed in claim 1, comprising at least one attachment chain having a first end secured to the mounting structure and a second end securable to the motorized vehicle.

8. A track assembly as claimed in claim 7, wherein the second end is securable to the wheel axle.

9. A track assembly as claimed in claim 1, wherein the mounting structure comprises two spaced-apart side guiding plates including rollers for receiving the vehicle wheel therebetween and being mounted externally of the longitudinal endless track belt.

10. A track assembly as claimed in claim 9, wherein the distance between the side guiding plates is adjustable.

11. A motorized vehicle including four detachable track assemblies to support the vehicle onto a ground surface and having four wheels, each one of the track assemblies comprising:
a frame;
a longitudinal endless track belt movably mounted to the frame;
inner wheels rotatably mounted to the frame and in contact with an inner surface of the longitudinal endless track belt;
at least two driving gears disposed externally to the longitudinal endless track belt and being in frictional driving engagement with one of the four motorized vehicle wheels for rotation therewith, located above the longitudinal endless track belt and drivingly connected to the endless track belt for transmitting motion thereto, each one of the driving gears having a central rotation axis with a plurality of elongated traction bars extending substantially parallel and circumferentially to the central rotation axis, the elongated traction bars being radially spaced-apart from the rotation axis and from one another.

12. A motorized vehicle as claimed in claim 11, wherein the driving gears have open ends.

13. A motorized vehicle as claimed in claim 11, wherein the driving gears are drivingly meshed with the longitudinal endless track belt.

14. A motorized vehicle as claimed in claim 11, wherein the driving gears comprise a radial support connecting an axle of the driving gears and the traction bars and maintaining the traction bars in a radially spaced-apart relationship and each one of the traction bars having two opposed ends unattached to the axle and thereby defining the open ends of the driving gears.

15. A motorized vehicle as claimed in claim 11, wherein the driving gears comprise a plurality of traction bar units, each one of the traction bar units including at least two traction bars, the traction bar units being spaced-apart from one another and defining a channel therebetween, the elongated track belt being in meshing engagement with the channels defined between two circumferentially consecutive traction bar units.

16. A motorized vehicle as claimed in claim 11, comprising at least one attachment chain having a first end secured to the mounting structure and a second end securable to the motorized vehicle.

17. A motorized vehicle as claimed in claim 11, wherein the mounting structure comprises two spaced-apart side guiding plates including rollers for receiving the vehicle wheel therebetween and being mounted externally of the longitudinal endless track belt.

18. A driving gear for transferring power from a vehicle wheel to a track of a vehicle track assembly, the driving gear comprising a body in the shape of a hollow cylinder having two spaced-apart open ends, a central axle and a plurality of longitudinally oriented, and regularly circumferentially interspaced traction bars defining the cylindrical shape and being adapted for receiving traction from the vehicle wheel, and a plurality of channels interspersed between corresponding ones of the traction bars, the channels being shaped for evacuating snow from the track inside the hollow cylinder and out the two open ends.

19. A driving gear as claimed in claim 18, wherein the driving gear comprises a radial support connecting the axle and the traction bars and maintaining the traction bars in a radially spaced-apart relationship each one of the traction bars having two opposed ends unattached to the axle and thereby defining the open ends of the driving gears.

20. A driving gear as claimed in claim 18, wherein the driving gear comprises a plurality of traction bar units, each one of the traction bar units including at least two traction bars, the traction bar units being spaced-apart from one another and defining the interspersed channels therebetween.

21. A method of mounting at least one vehicle track assembly to a vehicle, the method comprising laying the at least one vehicle track assembly on the ground, attaching at least one ramp to one end of each one of the at least one vehicle track assembly, displacing the vehicle for a wheel thereof to mount the at least one ramp and drop into an operative position in the at least one vehicle track assembly, and removing the at least one ramp.

22. A method as claimed in claim 21, wherein the at least one ramp comprises an attachment bar mating and engageable with a channel defined in a driving gear of the at least one track assembly for preventing rotation of the driving gear.

23. A method as claimed in claim 21, wherein attaching the at least one ramp comprises inserting a first attachment male member of the at least one ramp in a mating slot of the at least one track assembly and inserting an attachment bar of the at least one ramp in a mating channel defined in a driving gear of the at least one track assembly and between two circumferentially consecutive traction bars of the at least one track assembly for preventing rotation of the driving gear.

24. A track unit kit for a motorized vehicle having a plurality of wheels, the track unit kit comprising:
a track assembly including a frame, a longitudinal endless track belt movably mounted to the frame, inner wheels rotatably mounted to the frame and in contact with an inner surface of the longitudinal endless track belt, and at least two driving gears disposed externally to the longitudinal endless track belt, located above the longitudinal endless track belt and drivingly connected to the endless track belt for transmitting motion thereto, each one of the driving gears having a central rotation axis with a plurality of elongated traction bars extending substantially parallel and circumferentially to the central rotation axis, the elongated traction bars being radially spaced-apart from the rotation axis and from one another for defining channels therebetween; and
a ramp for mounting and dismounting the vehicle wheels from the track assembly above the endless track belt and between the driving gears, the ramp having an attachment bar mating and engageable with one of the channels defined in the driving gears and preventing rotation of the driving gears during mounting and dismounting the vehicle wheels from the track assembly.

25. A track unit kit as claimed in claim 24, wherein the frame of the track assembly comprises a slot defined therein and the ramp comprises an attachment male member removably insertable in the slot for attaching the ramp to the track assembly.
